(19) United States
(12) Patent Application Publication
(10) Pub. No.: US 2020/0187650 A1
(43) Pub. Date: Jun. 18, 2020

(54) Safety Lock for Drawers

(71) Applicant: LEYO HOLDINGS SDN BHD, BATU PAHAT (MY)

(72) Inventor: Teck Lai Ng, ULU TIRAM (MY)

(21) Appl. No.: 16/641,302

(22) PCT Filed: Apr. 27, 2018
(86) PCT No.: PCT/MY2018/050023

§ 371 Date: Feb. 24, 2020

(30) Foreign Application Priority Data
Aug. 23, 2017 (MY) PI 2017703114

(51) Int. Cl. A47B 88/50; E05B 65/463

(52) U.S. Cl. CPC A47B 88/50; E05B 2063/0095; E05B 65/463

(57) ABSTRACT

The present invention discloses a cabinet (100) comprising: at least one drawer (110); at least one stopping means attached to the outer side wall of the drawer (110); and at least one hooking means for engaging the stopping means; wherein the hooking means is pivotally attached to inner side of cabinet (100) in a way such that when the cabinet (100) tilts, the hooking means will be rotated and engaged with the stopping means for preventing the drawer (110) from falling out of the cabinet (100).

### FIELD OF INVENTION

The invention relates to a safety device. More particularly, the invention relates to a safety device for preventing spontaneous opening of drawers upon tilting.

### BACKGROUND OF THE INVENTION

Earthquakes often results in different magnitude of shaking. Sometimes, the magnitude can be strong enough to cause furniture to fall down. Fatal accidents may happen when the furniture comes with drawers. Such accidents may include the tilting of furniture that causes the drawers to slide out and hit onto the nearby person. In another reported incident, children who are attempting to climb the furniture have caused the furniture to overturn and results in injuries. These accidents have caught the public's attention on the safety of drawers. Therefore, it is crucial to have a safety device that applies to the drawers for avoiding the aforementioned accidents.

Over the years, there are a few patented technologies related to the aforementioned safety device. Of interest in respect to drawer slide child lock is disclosed in U.S. Pat. No. 5,823,649A, this patent provides teaches on a safety device suitable for preventing the opening of a drawer by having a restraining member mounted to a lever that is accessible when the drawer is partially opened. The restraining member alternatively engages a cabinet-mounted drawer slide roller through a slot in the drawer-mounted drawer slide roller through a slot in the drawer-mounted drawer slide or engages the interior of cabinet face. However, the drawback of this device is that the restraining member need to be disengages manually to allow for conventional operation of the drawer.

Besides, another patent document U.S. Pat. No. 4,139,249A discloses a child-proof cabinet latch with a spring biased restraining member. The restraining member is movable between a first position to permit only limited opening movement of the drawer and a second position where the drawer movement is not limited. Nonetheless, the disclosed invention is less reliable due to the possible mechanical failure.

To summarize, there is a need to provide a safety device for drawers to overcome the above-referred drawbacks. This invention provides such a device.

### SUMMARY OF INVENTION

The main objective of the invention is to a cabinet comprising at least one drawer, at least one stopping means attached to the outer side wall of the drawer, and at least one hooking means for engaging the stopping means, wherein the hooking means is pivotally attached to inner side of cabinet in a way such that when the cabinet is tilt, the hooking means will be rotated and engaged with the stopping means for preventing the drawer from falling out of the cabinet.

Preferably, the drawer further comprising means for allowing the drawer to be slidable between open and close positions.

Preferably, the hooking means is generally a C-shaped plate.

Preferably, the hooking means further includes a tooth-like surface located at the inner side of the plate to enhance the engagement of the plate to the stopping means.

Preferably, the hooking means further includes means for allowing the pivotally attachment of the hooking means on to the cabinet.

Preferably, the stopping means is a protrusion extended from the drawer.

Preferably, the tilting of the cabinet will cause the plate to rotate in a way such that its bottom end will hook on to the protrusion for preventing the drawer from falling out of the cabinet.

The second objective of this invention is to provide a safety device for preventing a drawer from falling out of a cabinet comprising a generally C-shaped plate body having a top end and a bottom end and means for pivotally attaching of the plate body to the cabinet wherein the tilting of the cabinet will cause the plate body to rotate in a way such that the bottom end will hook onto a part of the drawer.

Preferably, the bottom end includes a tooth-like inner surface for enhancing the engagement of the bottom end to the drawer.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a diagram illustrating the cabinet with safety device assembly.

FIG. 2 is a diagram illustrating the safety device.

### DETAILED DESCRIPTION OF THE INVENTION

The invention will now be described in greater detail, by way of example, with reference to the drawings.

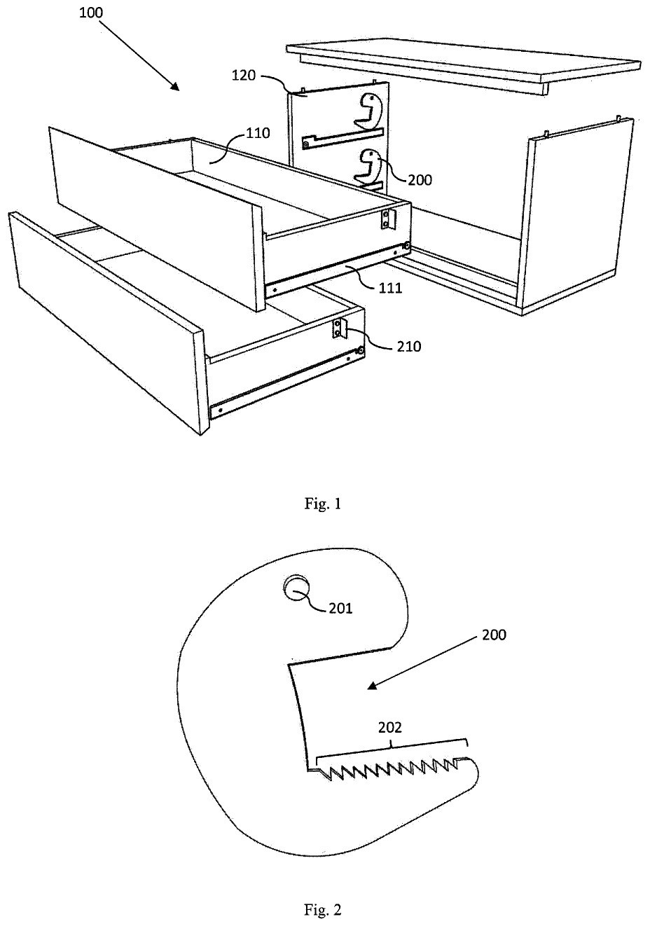

FIG. 1 illustrates a cabinet 100 with a safety device integrated for limiting the movement of the drawers 110. The cabinet 100 is designed to house at least one drawer 110 whereby the drawer 110 is slidably received within the cabinet by a rail 111 assembly at each side. The rail 111 comprises a housing rail component being mounted on the cabinet 100 and a drawer rail component being mounted on the sides of the drawer 110 such that the drawer rail component is received by the housing rail for allowing the sliding displacement of drawer 110 between open and closed positions. The safety device in accordance with the present invention includes a protrusion 210 being attached to the outer side wall of the drawer 110 above the drawer rail 111 and a corresponding hooking plate 200 being generally attached to the inner side of the cabinet 100. Preferably, each drawer 110 is fitted with two safety devices one at each side.

FIG. 2 illustrated the detail construction of the safety device. The safety device comprises generally a C-shaped hooking plate 200 with tooth-like surface 202 at the bottom end and a heavier portion on the top end. The C-shaped hooking plate 200 comprising a hole 201 for a screw fastener for attaching the C-shaped hooking plate 200 to the inner side wall of the cabinet 100. The C-shaped hooking plate 200 is fastened in a way such that having some vertical tolerance for allowing the C-shaped hooking plate 200 to be rotated freely. The safety device also further comprises a generally L-shaped protrusion 210 act as the stopping means. The L-shaped protrusion 210 includes at least a hole for allowing a fastener to pass through for securing the L-shaped protrusion 210 onto the drawer side wall.

The safety device swings between two positions namely lock position and unlock position, whereby the safety device is in the locking position when the hooking plate 200 is engaged with the protrusion 210 and the unlock position when the hooking plate 200 is disengaged with the protrusion 210. In operation, the hooking plate 200 is attached to the cabinet 100 in a way such that it will always maintain an upright position in relative to the ground via gravitational force regardless of how much the cabinet 100 tilts until the safety device is in a locking position. Nonetheless, when the cabinet 100 tilts, the hooking plate 200 will rotate in relative to the cabinet 100 to a locking position. Preferably, the tilting of the cabinet 100 caused by a substantial vibration of a moving vehicle, earthquake, or a child attempt to climb or enter an open drawer which may causes overturning of the cabinet 100.

In another embodiment, when the position of the cabinet 100 is restored back to the normally position, the hooking plate 200 will be rotated back to the original position. As a result, the sliding passageway of the drawer 110 is unlocked so that the drawer 110 can be slid between open and closed position freely. The automatic restoration of the hooking plate 200 enabling uninterrupted opening of the drawer 110 and requiring combined operation in closing a drawer 110.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1.-9. (canceled)

10. A cabinet, comprising:
at least one drawer;
at least one stopping means attached to an outer side wall of the drawer; and
at least one hooking means for engaging the stopping means;
wherein the hooking means is pivotally attached to an inner side of the cabinet in a way such that when the cabinet tilts, the hooking means are rotated and engaged with the stopping means for preventing the drawer from falling out of the cabinet.

11. The cabinet as claimed in claim 10, further comprising guides for the drawer to be slidably movable between an open and a closed position.

12. The cabinet as claimed in claim 10, wherein the hooking means is a generally C-shaped plate.

13. The cabinet as claimed in claim 12, wherein the hooking means further includes a tooth-like surface on an inner side of the plate to enhance the engagement of the plate to the stopping means.

14. The cabinet as claimed in claim 13, wherein the plate is pivotally attached to the inner side of cabinet by a fastener.

15. The cabinet as claimed in claim 10, wherein the stopping means is a protrusion extended from the drawer.

16. The cabinet as claimed in claim 15, wherein the tilting of the cabinet will cause the plate to rotate in a way such that a bottom end thereof will hook on to the protrusion for preventing the drawer from falling out of the cabinet.

17. A safety device for preventing a drawer from falling out of a cabinet, comprising:
a generally C-shaped plate body having a top end and a bottom end; and
means for pivotally attaching the plate body to the cabinet;
wherein tilting of the cabinet will cause the plate body to rotate in a way such that a bottom end thereof hooks onto a part of the drawer.

18. The safety device as claimed in claim 17, wherein the bottom end includes a tooth-like inner surface for enhancing the engagement of the bottom end to the drawer.
